(19) United States
(12) Patent Application Publication
(10) Pub. No.: US 2008/0087635 A1
(43) Pub. Date: Apr. 17, 2008

(54) Method of etching a nickel oxide layer and method of manufacturing a storage node

(75) Inventors: Soon-won Hwang, Yongin-si (KR); Jung-hyun Lee, Yongin-si (KR); Seok-jae Chung, Yongin-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 11/907,091

(22) Filed: Oct. 9, 2007

(30) Foreign Application Priority Data
Oct. 17, 2006 (KR) 10-2006-0101047

(51) Int. Cl. B44C 1/22

(52) U.S. Cl. 216/41

(57) ABSTRACT

An etching method of a nickel oxide layer and a method of manufacturing a storage node of a resistive memory including the nickel oxide layer are provided. The method of etching the nickel oxide layer includes forming a nickel oxide layer on a substrate, forming a mask pattern on a desired region of the nickel oxide layer, removing the nickel oxide layer around the mask pattern using plasma generated from a mixed etching gas having a desired ratio of a main gas and an additive gas and removing the mask pattern.

### PRIORITY STATEMENT

This application claims the benefit of priority under 35 U.S.C. §119 from Korean Patent Application No. 10-2006-0101047, filed on Oct. 17, 2006, in the Korean Intellectual Property Office, the disclosure of which is incorporated herein in its entirety by reference.

### BACKGROUND

1. Field

Example embodiments relate to a method of etching a nickel (Ni) oxide layer used as a variable resistance layer of a resistive memory. Other example embodiments provide a method of manufacturing a storage node in a resistive memory in which a nickel oxide layer is used as a variable resistance layer.

2. Description of the Related Art

A nickel oxide (NiO) is a type of transition metal oxide (TMO) that may be used as a data storage layer of a resistive memory, which is a non-volatile memory.

Nonvolatile memories (e.g., flash memories) are characterized by their ability to maintain stored data after power is turned off. Flash memories, unlike volatile memories, have non-volatile characteristics. Flash memories have low integration density and slow operating speed in comparison to dynamic random access memories (DRAMs).

Nonvolatile memories have been the focus of recent research (e.g., magnetic random access memories (MRAMs), ferroelectric random access memories (FRAMs), phase-change random access memories (PRAMs) and resistance random access memories (RRAMs)).

FIG. 1 is a diagram illustrating a cross-sectional view of a conventional resistive memory having a variable resistance layer.

Referring to FIG. 1, a gate oxide layer 13 and a gate electrode layer 14 may be formed on a substrate 11 that includes a first dopant region 12a and a second dopant region 12b. One of the first dopant region 12a or the second dopant region 12b is a source and the other one is a drain, respectively. The gate electrode layer 14, the first dopant region 12a, and the second dopant region 12b form a transistor. An interlayer insulating layer 16 may be formed on the substrate 11 over the transistor. A contact hole 20 that exposes the second dopant region 12b of the substrate 11 may be formed in the interlayer insulating layer 16. The contact hole 20 is filled with a conductive plug 22. A storage node S may be formed on the interlayer insulating layer 16 of the memory of FIG. 1.

The storage node S includes a lower electrode 30, a variable resistance layer 32 and an upper electrode 34 sequentially formed. As shown in FIG. 1, a 1 transistor (T)-1 resistor (R) structure may include a resistive memory, which uses the variable resistance layer 32 as a data storage layer, connected to a transistor functioning as a switch.

In other example embodiments, a 1 diode (D)-1 resistor (R) structure may be formed by connecting the resistive memory to a diode structure that includes a p-type semiconductor layer and an n-type semiconductor layer.

The variable resistance layer 32 of the storage node S may be an individual NiO layer. The variable resistance layer 32 may have a multiple layer structure in which a plurality of other protective layers are included.

The storage node S depicted in FIG. 1 may be fabricated using the method shown in FIGS. 2 and 3.

FIGS. 2 and 3 are diagrams illustrating a method of forming the conventional storage node of FIG. 1. Referring to FIG. 2, after sequentially forming a lower electrode layer 41, a NiO layer 42 and an upper electrode layer 43 on a desired region of a substrate 40, a mask pattern M that defines a region for forming the storage node S may be formed on the upper electrode layer 43. As depicted in FIG. 3, the lower electrode layer 41, the NiO layer 42 and the upper electrode layer 43 may be etched using the mask pattern M as an etch mask to form the storage node S.

In a conventional semiconductor process, if an ion milling method using argon (Ar) gas for etching the NiO layer 42 is performed, a by-product 45 having an ear shape may remain on a side surface of the storage node S due to re-deposition of etched materials. The by-product 45 may cause an electrical short circuit within the lower electrode layer 41, the NiO layer 42 and the upper electrode layer 43 that form the storage node S.

If the NiO layer 42 of the storage node S is etched using a reactive ion etching method, then it may be difficult to form a volatile etching product. As such, the NiO layer 42 is etched at a temperature higher than 300° C. The higher temperature may cause thermal damage to a manufactured resistive memory.

If the storage node S is formed using a lift-off method, then the productivity of the resistive memory decreases.

### SUMMARY

Example embodiments relate to a method of etching a nickel (Ni) oxide layer used as a variable resistance layer of a resistive memory. Other example embodiments also provide a method of manufacturing a storage node in a resistive memory in which the nickel oxide layer is used as a variable resistance layer.

Example embodiments provide a method of etching a nickel oxide layer that is a micrometer (μm) or less in size having a desired profile by reducing, or preventing, re-deposition of an etched by-product on a side surface of an etched product. Other example embodiments provide a method capable of reducing (or minimizing) thermal damage.

According to example embodiments, there is provided a method of etching a nickel oxide layer including forming a nickel oxide layer on a substrate, forming a mask pattern on a desired region of the nickel oxide layer, removing the nickel oxide layer around the mask pattern using plasma generated from a mixed-etching gas, in which a main gas and an additive gas are mixed in a desired ratio (hereinafter “the mixed ratio”) and removing the mask pattern.

Removing the nickel oxide layer may further include loading the substrate with the mask pattern in an inductively coupled plasma etching apparatus, and producing plasma in an upper space of the substrate by applying a desired power source and a bias voltage while uniformly supplying the mixed etching gas into the inductively coupled plasma etching apparatus.

The mixed ratio may include 40% to 70% of the main gas. The main gas may be at least one selected from the group consisting of Cl₂, BCl₃, BBr₃, HBr, CF₄, C₂F₆, C₄F₈, CHF₃, CO and mixtures thereof.

The source power applied to the inductively coupled plasma etching apparatus may be 500 W to 800 W. The bias voltage applied to the inductively coupled plasma etching apparatus may be 100V to 150V.

The nickel oxide layer may be removed at a temperature of approximately 25° C.

According to example embodiments, there is provided a method of manufacturing a storage node of a resistive memory having a nickel oxide layer, the method including sequentially forming a lower electrode layer, a nickel oxide layer and an upper electrode layer on a substrate; forming a mask pattern on a desired region of the upper electrode layer; forming a storage node of the resistive memory by sequentially removing the upper electrode layer, the nickel oxide layer and the lower electrode layer around the mask pattern using plasma generated from a mixed etching gas in which a main gas and an additive gas are mixed in a desired ratio and removing the mask pattern.

### BRIEF DESCRIPTION OF THE DRAWINGS

Example embodiments will be more clearly understood from the following detailed description taken in conjunction with the accompanying drawings. FIGS. 1-12 represent non-limiting, example embodiments as described herein.

FIG. 1 is a diagram illustrating a cross-sectional view of a conventional resistive memory;

FIGS. 2 and 3 are diagrams illustrating cross-sectional views of a method of forming the conventional storage node of the memory of FIG. 1;

FIGS. 4 through 6 are diagrams illustrating cross-sectional views of a method of etching a nickel oxide layer according to example embodiments;

FIG. 7 is a diagram illustrating a cross-sectional view of an inductively coupled plasma etching apparatus used for etching the nickel oxide layer according to example embodiments;

FIG. 8 is a scanning electron microscope (SEM) image of a resultant product etched using the method of etching a nickel oxide layer according to example embodiments;

FIG. 9 is an SEM image of a nickel oxide layer etched using a conventional ion milling method; and

FIGS. 10 through 12 are diagrams illustrating cross-sectional views of a method of manufacturing a storage node of a resistive memory according to example embodiments.

### DETAILED DESCRIPTION OF THE INVENTION

Various example embodiments will now be described more fully with reference to the accompanying drawings in which some example embodiments are shown. In the drawings, the thicknesses of layers and regions may be exaggerated for clarity.

Detailed illustrative embodiments are disclosed herein. However, specific structural and functional details disclosed herein are merely representative for purposes of describing example embodiments. This invention may, however, may be embodied in many alternate forms and should not be construed as limited to only the example embodiments set forth herein.

Accordingly, while the example embodiments are capable of various modifications and alternative forms, embodiments thereof are shown by way of example in the drawings and will herein be described in detail. It should be understood, however, that there is no intent to limit example embodiments to the particular forms disclosed, but on the contrary, the example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of the example embodiments.

Spatially relative terms, such as “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the present invention is not limited to the example embodiments described.

Example embodiments relate to a method of etching a nickel (Ni) oxide layer used as a variable resistance layer of a resistive memory. Other example embodiments provide a method of manufacturing a storage node in a resistive memory in which a nickel oxide layer is used as a variable resistance layer.

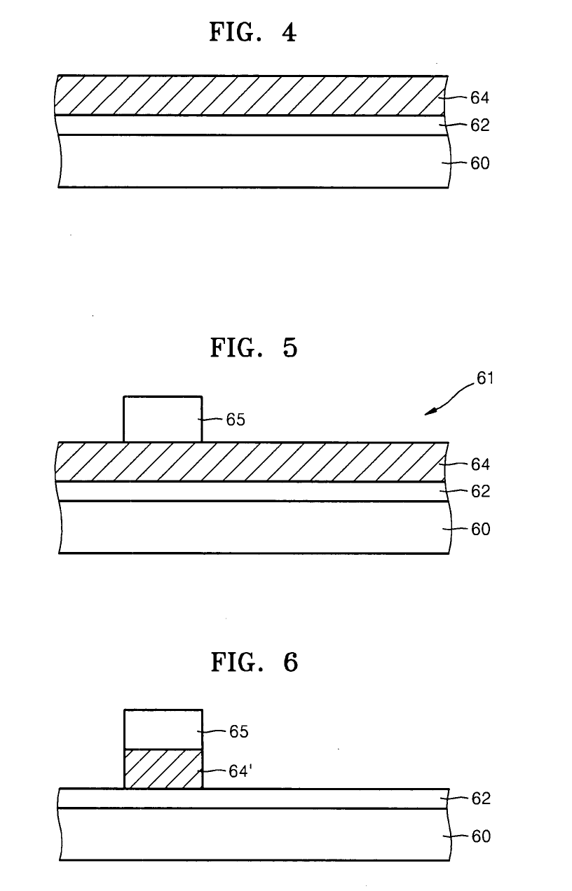

A method of etching a nickel oxide layer according to example embodiments will now be described with reference to FIGS. 4 through 6.

FIGS. 4 through 6 are diagrams illustrating cross-sectional views of a method of etching a nickel oxide layer according to example embodiments.

Referring to FIG. 4, an insulating layer 62 and a nickel oxide layer 64 are formed on a substrate 60. A silicon substrate may be used as the substrate 60. The insulating layer 62 may be a silicon oxide. However, example embodiments are not limited thereto.

Referring to FIG. 5, a mask pattern 65 covering a desired region of the nickel oxide layer 64 is formed using a desired exposure apparatus (e.g., a photolithography process that uses a KrF stepper). The mask pattern 65 is a photosensitive film pattern. The mask pattern is a micrometer or less in size. The size (micrometer or less) of the mask pattern 65 is transferred to a material film formed under the mask pattern 65 in a subsequent etching process. As such, the nickel oxide layer 64 formed from the mask pattern 65 has a horizontal width of a micrometer or less.

Referring to FIG. 6, the nickel oxide layer 64 may be dry etched from the resultant product shown in FIG. 5 using the mask pattern 65 as an etch mask. An etched nickel oxide layer 64′ may be formed by removing the mask pattern 65.

The etched nickel oxide layer 64′ is sequentially etched using a desired plasma etching process. In the plasma etching process, it is desirable to independently control the mixed ratio of a gas mixture used as an etch gas and/or a bias power applied to the substrate.

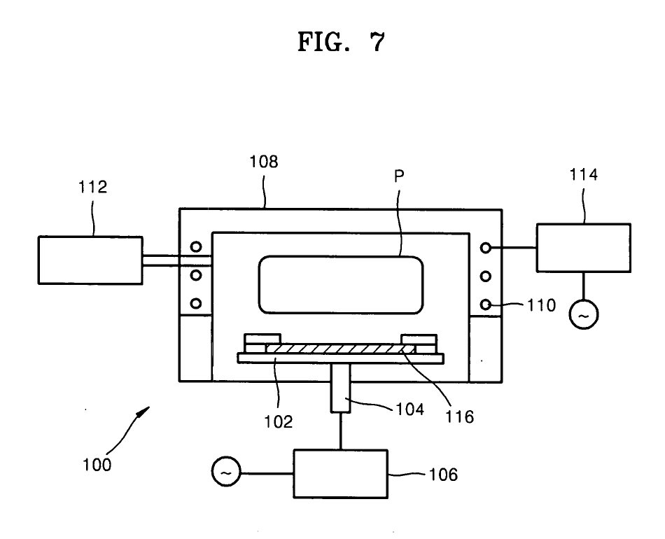

FIG. 7 is a diagram illustrating a cross-sectional view of an inductively coupled plasma etching apparatus 100 used for etching the nickel oxide layer according to example embodiments.

Referring to FIG. 7, the inductively coupled plasma etching apparatus 100 includes a stage 102 on which a substrate is loaded, a chuck 104 that supports the stage 102, a first radio frequency (RF) matching unit 106 for independently controlling a desired bias power applied to the substrate that is loaded on the stage 102 by connecting to the chuck 104.

The inductively coupled plasma etching apparatus 100 further includes a chamber 108 in which a plasma etching process is performed, a coil 110 mounted in an upper wall of the chamber 108 surrounding a space above the stage 102 in the chamber 108, and an optical emission spectrometer 112 for checking the progress of etching in the chamber 108.

Light, which is emitted through an optical window (not shown) provided on the chamber 108, is analyzed by the optical emission spectrometer 112. Etching data (i.e., the etching progress in the chamber 108 or the type of by-product produced during the etching process) may be obtained through the optical emission spectrometer 112.

A second RF matching unit 114 independently controls power applied to the coil 110 of the chamber 108. Although not shown in the drawing, the inductively coupled plasma etching apparatus 100 is designed such that helium (He) gas may flow inside the stage 102 so that the temperature of (or heat from) the chuck 104 may be more effectively transferred to the substrate loaded on the stage 102.

If the nickel oxide layer is etched in the inductively coupled plasma etching apparatus 100, then the first RF matching unit 106 applies a bias voltage of 300V or less. According to other example embodiments, the bias voltage may be approximately 100V-150V. The second RF matching unit 114 applies a source power of 1.5-kW or less to the coil 110. The source power may be 500 W-800 W.

Plasma including ions, radicals and electrons that are produced from a mixed etch gas, which is uniformly introduced into the chamber 108 and used for etching, is generated in an upper space P over the stage 102 by the bias voltage applied by the first RF matching unit 106 and the source power applied by the second RF matching unit 114 or a combination thereof.

The nickel oxide layer 64 is etched by loading the substrate 60 with the mask pattern 65 formed on the nickel oxide layer 64 (interchangeably referred to as “resultant product 61” as shown in FIG. 5) on the stage 102. For convenience of explanation, a resultant product 116 in FIG. 9 represents the resultant product 61 loaded on the stage 102 shown in FIG. 5. The resultant product 116 may be fixed by fixing members (not shown) provided on the stage 102 until the etching of the nickel oxide layer 64 is completed. After the resultant product 116 is fixed on the stage 102, a mixed etching gas is uniformly sprayed in the upper space P over the stage 102 through a nozzle (not shown) mounted on a ceiling of the chamber 108. The mixed etching gas may include chlorine (Cl₂) gas as a main gas and an additive gas (e.g., argon (Ar) gas).

An etching characteristic of the nickel oxide layer may be optimized (or increased) by varying factors such as a mixed ratio of the mixed etching gas, the main power applied to the inductively coupled plasma etching apparatus 100 to induce discharge of the mixed etching gas, the bias power applied to the substrate loaded on the stage 102, the substrate temperature, the process pressure, the gas flow rate, etc.

The nickel oxide layer may be more effectively etched if the mixed etching gas includes 40% to 70% of Cl₂ gas. The main gas of the mixed etching gas may be BCl₃, BBr₃, HBr, CF₄, C₂F₆, C₄F₈, CHF₃, CO, Cl₂ and mixtures thereof.

If the mixed etching gas is sprayed in the upper space P over the resultant product 116 by the nozzle (not shown) mounted on the chamber 108, a desired source power (e.g., 500 W) may be applied to the inductively coupled plasma etching apparatus 100. As such, radicals and ions plasma (that may be used for etching) may be produced from the mixed etching gas. The nickel oxide layer 64 around the mask pattern 65 of the resultant product 116 may be etched by the plasma. After the nickel oxide layer 64 around the mask pattern 65 is etched, the mask pattern 65 is removed.

If the inductively coupled plasma etching apparatus 100 and the mixed etching gas having the mixed ratio are used to etch the nickel oxide layer, the plasma density increases. In other words, the density of the radicals and ions participating in the etching reaction increases. As such, the plasma is further activated and a by-product produced during the etching process performed at a temperature of 100° C. or less, more desirably at room temperature of approximately 25° C., has a higher volatility.

As described above, because the etching process for forming the nickel oxide layer 64 is performed by a low temperature process of 25° C. to 100° C., opposed to a conventional high temperature process (e.g., a few hundred degrees Celsius), thermal damage to the nickel oxide layer 64 in the etching process may be prevented (or reduced). As described above, because the etch by-product produced using the low temperature process has a higher volatility, the re-deposition of the etch by-product on the etched nickel oxide layer 64 is prevented (or reduced), increasing the profile of the nickel oxide layer 64 in comparison to the conventional art.

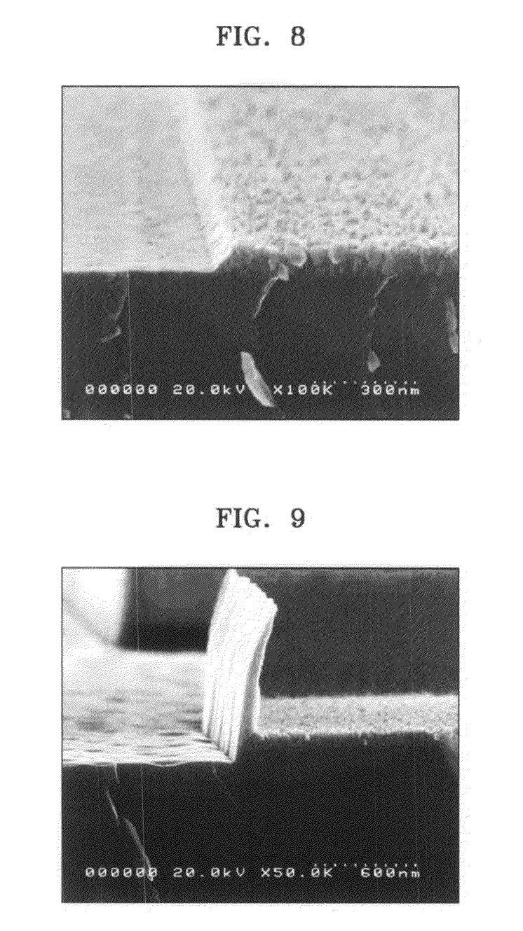

FIG. 8 is a scanning electron microscope (SEM) image of a resultant product etched using the method of etching a nickel oxide layer according to example embodiments. FIG. 9 is an SEM image of a nickel oxide layer etched using a conventional ion milling method. FIGS. 8 and 9 illustrate resultant products of etched nickel oxide layers after a silicon oxide layer and the nickel oxide layer are sequentially formed on a substrate.

Referring to FIG. 9, an etch by-product is formed on a side surface of the nickel oxide layer in the conventional ion milling process. Due to the etch by-product, it may be difficult to apply a memory that uses a variable resistance layer using the nickel oxide layer.

Referring to FIG. 8, the pattern of the nickel oxide layer has a clean etch cross-section. As such, the etching method according to the example embodiments allows the nickel oxide layer to be used as a variable resistance layer of a resistive memory.

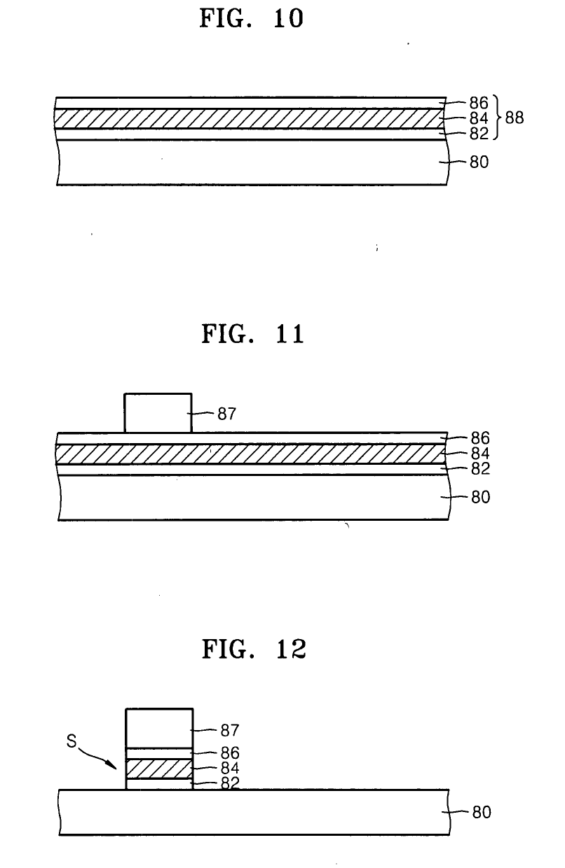

A method of manufacturing a storage node of a resistive memory according to example embodiments will now be described with reference to FIGS. 10 through 12.

FIGS. 10 through 12 are diagrams illustrating cross-sectional views of a method of manufacturing a storage node of a resistive memory according to example embodiments.

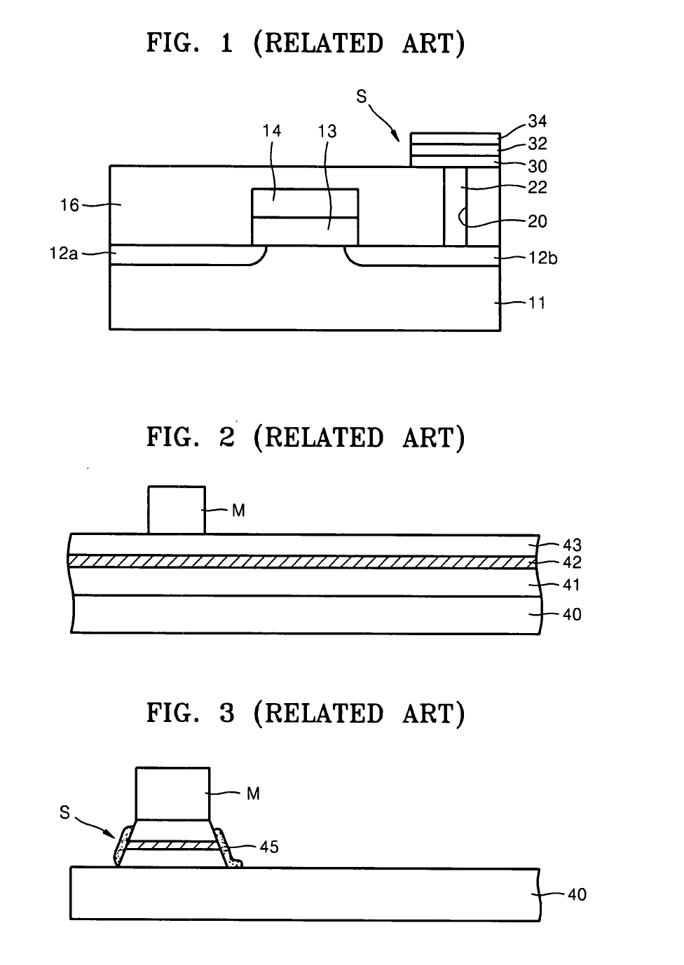

Referring to FIG. 10, a lower electrode layer 82, a nickel oxide layer 84, an upper electrode layer 86, which form a storage node 88 of a resistive memory, are sequentially formed on a substrate 80. The substrate 80 denotes the material layers of FIG. 1 except the storage node.

Referring to FIG. 11, a mask pattern 87 that covers a desired region of the upper electrode layer 86 is formed using an exposure process (e.g., a photolithography process that uses a KrF stepper). The mask pattern 87 is a photosensitive pattern. The mask pattern 87 is a micrometer or less in size. The size of the mask pattern 87 may be transferred to a material film formed under the mask pattern 87 in a subsequent process. The horizontal width of the nickel oxide layer 84 formed from the mask pattern 87 will be a micrometer or less in size.

Referring to FIG. 12, the upper electrode layer 86, the nickel oxide layer 84, and the lower electrode layer 82 are sequentially etched using the mask pattern 87 as an etch mask. The mask pattern 87 is removed, forming storage node S, in which the lower electrode layer pattern 82, the nickel oxide layer pattern 84 and the upper electrode layer pattern 86 are sequentially stacked.

The upper electrode layer 86, the nickel oxide layer 84 and the lower electrode layer 82 are sequentially etched using the inductively coupled plasma etching apparatus 100 of FIG. 7. In the etching process, different etching conditions may be applied according to the material layer to be etched.

The etching characteristics of the upper electrode layer 86, the nickel oxide layer 84 and the lower electrode layer 82 may be increased by optimizing factors such as a mixed ratio of the mixed etching gas, the main power applied to the inductively coupled plasma etching apparatus 100 to induce discharge of the mixed etching gas, the bias power applied to the substrate loaded on the stage 102, the substrate temperature, the process pressure, the gas flow rate, etc.

The mixed etching gas may include Cl₂ gas as a main gas and an additive gas (e.g., argon (Ar) gas). The nickel oxide layer 84 is more effectively etched if the mixed etching gas includes 40% to 70% of Cl₂ gas. The main gas may include BCl₃, BBr₃, HBr, CF₄, C₂F₆, C₄F₈, CHF₃, CO, Cl₂, and mixtures thereof.

After the upper electrode layer 86, the nickel oxide layer 84, and the lower electrode layer 82 around the mask pattern 87 are etched, the mask pattern 87 may be removed.

As described above, because the etching process for forming the nickel oxide layer 84 is performed using a low temperature process at room temperature (i.e., approximately 25° C.), opposed to a high temperature process (i.e., a few hundred degrees Celsius), thermal damage to the nickel oxide layer 84 in the etching process may be prevented or reduced. Because the etch by-product produced in the low temperature process has higher volatility, the re-deposition of the etch by-product on the etched nickel oxide layer 84 is prevented (or reduced), increasing the profile of the nickel oxide layer 84 in comparison to the conventional art.

As described above, an etch method of a nickel oxide layer according example embodiments is performed in an inductively coupled plasma etching apparatus. As the etching begins, a mixed etching gas, in which Cl₂ gas and Ar gas are mixed in an optimum ratio, is uniformly supplied to the inductively coupled plasma etching apparatus to generate plasma for etching. The density of the plasma (i.e., radicals and ions that participate in the etching process) increases in the inductively coupled plasma etching apparatus. As such, the etching process may be performed at a temperature lower than 100° C. (e.g., at approximately 25° C.). Thermal damage to the nickel oxide layer in the etching process may be prevented or reduced.

Because the plasma is more highly activated in comparison to the conventional art, an etch by-product produced by the etching process has higher volatility. The etch by-product is not re-deposited on the storage node due to the higher volatility of the etch by-product. As such, the storage node has a smoother side surface and a slope close to 90-degrees, increasing the profile of storage node in comparison to the conventional art.

What is claimed is:

1. A method of etching a nickel oxide layer, comprising:
forming a nickel oxide layer on a substrate;
forming a mask pattern on a desired region of the nickel oxide layer;
removing the nickel oxide layer around the mask pattern using plasma generated from a mixed etching gas having a desired ratio of a main gas and an additive gas; and
removing the mask pattern.

2. The method of claim 1, wherein the desired ratio includes 40% to 70% of the main gas.

3. The method of claim 1, wherein the main gas is at least one selected from the group consisting of Cl₂, BCl₃, BBr₃, HBr, CF₄, C₂F₆, C₄F₈, CHF₃, CO and mixtures thereof.

4. The method of claim 1, wherein removing the nickel oxide layer using the plasma further comprises:
loading the substrate with the mask pattern in a inductively coupled plasma etching apparatus; and
producing the plasma in an upper space over the substrate by applying a desired power source and a bias voltage while uniformly supplying the mixed etching gas into the inductively coupled plasma etching apparatus.

5. The method of claim 4, wherein the source power applied to the inductively coupled plasma etching apparatus is 500 W to 800 W.

6. The method of claim 4, wherein the bias voltage applied to the inductively coupled plasma etching apparatus is 100V to 150V.

7. The method of claim 1, wherein removing the nickel oxide layer using the plasma is performed at a temperature of 25° C.-100° C.

8. The method of claim 7, wherein removing the nickel oxide layer using the plasma is performed at a temperature of approximately 25° C.

9. The method of claim 7, wherein removing the nickel oxide layer using the plasma produces a volatile by-product.

10. The method of claim 7, wherein the nickel oxide layer is not thermally damaged after using the plasma.

11. A method of manufacturing a storage node having a resistive memory including a nickel oxide layer, the method comprising:
sequentially forming a lower electrode layer, a nickel oxide layer, and an upper electrode layer on a substrate;
forming a mask pattern on a desired region of the upper electrode layer;
forming the storage node by sequentially removing the upper electrode layer, the nickel oxide layer, and the lower electrode layer around the mask pattern using plasma generated from a mixed etching gas having a desired ratio of a main gas and an additive gas; and
removing the mask pattern.

12. The method of claim 11, wherein the desired ratio includes 40% to 70% of the main gas.

13. The method of claim 11, wherein the main gas is at least one selected from the group consisting of Cl₂, BCl₃, BBr₃, HBr, CF₄, C₂F₆, C₄F₈, CHF₃, CO and mixtures thereof.

14. The method of claim 11, wherein forming the storage node further comprises:
loading the substrate with the mask pattern in a inductively coupled plasma etching apparatus; and
producing the plasma in an upper space over the substrate by applying a desired power source and a bias voltage while uniformly supplying the mixed etching gas into the inductively coupled plasma etching apparatus.

15. The method of claim 14, wherein the source power applied to the inductively coupled plasma etching apparatus is 500 W to 800 W.

16. The method of claim 14, wherein the bias voltage applied to the inductively coupled plasma etching apparatus is 100V to 150V.

17. The method of claim 11, wherein removing the nickel oxide layer using the plasma is performed at a temperature of 25° C.-100° C.

18. The method of claim 17, wherein removing the nickel oxide layer using the plasma is performed at a temperature of approximately 25° C.

19. The method of claim 17, wherein removing the nickel oxide layer using the plasma produces a volatile by-product.

20. The method of claim 17, wherein the nickel oxide layer is not thermally damaged after using the plasma.
